(19) United States
(12) Patent Application Publication
(10) Pub. No.: US 2020/0045627 A1
(43) Pub. Date: Feb. 6, 2020

(54) METHODS OF REDUCING POWER CONSUMPTION IN A CELLULAR NETWORK BASED ON TRAFFIC ANALYTICS

(71) Applicant: CommScope Technologies LLC, Hickory, NC (US)

(72) Inventor: Michael R. WOLFE, Dallas, TX (US)

(21) Appl. No.: 16/340,357

(22) PCT Filed: Nov. 15, 2017
(86) PCT No.: PCT/US2017/061718

§ 371 Date: Apr. 8, 2019

Related U.S. Application Data
(60) Provisional application No. 62/427,340, filed on Nov. 29, 2016.

(51) Int. Cl. H04W 52/02; H04W 16/04; H04W 72/04; H04W 28/02; H04B 7/06; H04B 7/0413

(52) U.S. Cl. CPC H04W 52/0206; H04W 16/04; H04B 7/0413; H04W 28/0284; H04B 7/0604; H04W 72/0453

(57) ABSTRACT

A cellular base station collects data regarding a traffic load at the cellular base station, where the cellular base station supports service in at least a first transmit/receive frequency band and a second transmit/receive frequency band, analyzes the collected data, and reconfigures signal transmission equipment at the cellular base station to reduce power consumption at the cellular base station based on the analysis of the collected data.

### CROSS-REFERENCE TO RELATED APPLICATION

The present application claims priority to U.S. Provisional Patent Application Ser. No. 62/427,340, filed Nov. 29, 2016, the entire content of which is incorporated herein by reference as if set forth in its entirety.

### FIELD

The present invention relates to methods for reducing electrical power consumption in cellular communications networks and, more particularly, to reducing electrical power consumption based on analysis of the traffic patterns at base stations of the cellular communications network.

### BACKGROUND

Cellular communications networks are designed to provide radio coverage throughout large geographical areas. A cellular communications network includes a plurality of base stations that each provide radio coverage to a geographic region referred to as a cell. Each base station includes one or more radios and one or more antennas. Radio frequency (“RF”) signals are transmitted by the base station to mobile and fixed users within the cell, and RF signals are received at the base station from these mobile and fixed users. Each cell typically overlaps to an extent with neighboring cells so that mobile users may maintain connectivity as they move between cells. Each base station may be connected by wired and/or wireless links to a backhaul network.

### SUMMARY

Pursuant to embodiments of the present invention, methods of operating a cellular base station are provided in which data regarding a traffic load at the cellular base station is collected. The cellular base station supports service in at least a first transmit/receive frequency band and a second transmit/receive frequency band that is different than the first transmit/receive frequency band. The collected data is analyzed, and then signal transmission equipment at the cellular base station is automatically reconfigured to reduce power consumption at the cellular base station based on the analysis of the collected data.

In some embodiments, the first transmit/receive frequency band comprises a first capacity layer of the cellular base station and the second transmit/receive frequency band comprises a coverage layer of the cellular base station. In some embodiments, the method further comprises, in response to the analysis of the collected data, switching at least one mobile user from communicating in the first transmit/receive frequency band to communicating in the second transmit/receive frequency band prior to reconfiguring signal transmission equipment at the cellular base station to reduce power consumption at the cellular base station based on the analysis of the collected data.

In some embodiments, reconfiguring signal transmission equipment at the cellular base station to reduce power consumption at the base station comprises disabling a first radio. Disabling the first radio may comprise turning off the first radio or setting the first radio into a low power standby mode of operation.

In some embodiments, reconfiguring signal transmission equipment at the cellular base station to reduce power consumption at the cellular base station based on the analysis of the collected data may comprise reconfiguring the cellular base station to use fewer radios for multiple-input-multiple-output (“MIMO”) transmissions to at least one user or to switch from MIMO transmissions to single-input-single-output (“SISO”) transmission to the at least one user based on the analysis of the collected data in order to reduce power consumption at the cellular base station. In such embodiments, the amount of bandwidth assigned to the at least one user may be increased when switching the at least one user to SISO transmission.

In some embodiments, reconfiguring signal transmission equipment at the cellular base station to reduce power consumption at the cellular base station based on the analysis of the collected data may comprise reducing a peak transmit power for a first radio so that a first coverage area for a first sector of the first capacity layer is reduced to a second coverage area for the first sector that is smaller than the first coverage area in order to reduce power consumption at the cellular base station. In such embodiments, the method may further include, in response to the analysis of the collected data, switching at least one mobile user that is located in a portion of the first sector that is within the first coverage area but that is not within the second coverage area from communicating in the first transmit/receive frequency band to communicating in the second transmit/receive frequency band prior to reconfiguring the signal transmission equipment.

In some embodiments, the first radio may include a first transmit port that is connected to first radiating elements of an antenna that are configured to transmit and receive signals having a first polarization and a second transmit port that is connected to second radiating elements of an antenna that are configured to transmit and receive signals having a second polarization that is orthogonal to the first polarization. In such embodiments, reconfiguring signal transmission equipment at the cellular base station to reduce power consumption at the cellular base station based on the analysis of the collected data may comprise disabling the second transmit port while continuing to transmit signals through the first transmit port.

In some embodiments, analyzing the collected data may comprise developing a static algorithm for reconfiguring the signal transmission equipment at the cellular base station to reduce the power consumption at the cellular base station based on the analysis of the collected data.

In some embodiments, the static algorithm may reconfigure the signal transmission equipment at the cellular base station based on a time of day and/or a day of the week.

In some embodiments, the method may further comprise determining that insufficient signal transmission equipment is available to meet the traffic load after reconfiguring the signal transmission equipment at the cellular base station; and then enabling additional signal transmission equipment at the cellular base station.

In some embodiments, reconfiguring signal transmission equipment at the cellular base station to reduce power consumption at the cellular base station based on the analysis of the collected data may comprise dynamically reconfiguring signal transmission equipment at the cellular base station in response to changes in the traffic load.

In some embodiments, the collected data may include at least one of a number of connected users within the cell, a total throughput, a dropped call rate, a number of users that do not have service, a connection success rate, and user locations within a cell served by the cellular base station.

In some embodiments, reconfiguring signal transmission equipment at the cellular base station to reduce power consumption at the cellular base station based on the analysis of the collected data may comprise reconfiguring signal transmission equipment for a first sector of the cellular base station to reduce power consumption while not reconfiguring signal transmission equipment for a second sector of the cellular base station based on the analysis of the collected data.

### BRIEF DESCRIPTION OF THE DRAWINGS

FIG. 1 is a schematic diagram illustrating a cellular base station.

FIG. 2 is a schematic diagram illustrating the layered coverage architecture provided in 4G and 5G LTE networks.

FIG. 3 is a table illustrating an example time-of-day/day-of-the-week algorithm for reconfiguring signal transmission equipment (e.g., radios, antennas, etc.) at a base station for purposes of reducing power consumption.

FIG. 4A is a schematic diagram illustrating how a selected carrier may be disabled to reduce power consumption during periods of lower traffic in a cell.

FIG. 4B is a schematic diagram illustrating how multi-input-multi-output (“MIMO”) capabilities may be disabled to reduce power consumption during periods of lower traffic in a cell.

FIG. 4C is a schematic diagram illustrating how the transmit power may be reduced for selected carriers to reduce power consumption during periods of lower traffic in a cell.

FIG. 5 is a flow chart illustrating a method of operating a cellular base station to have reduced power consumption according to embodiments of the present invention.

### DETAILED DESCRIPTION

The “traffic load” at a base station refers to the amount of voice and data traffic that is being transmitted and received through the base station. The traffic load at a base station may vary widely based on, for example, the types and density of buildings and roads within the cell served by the base station, and may also vary widely as a function of time. For example, a base station for a cell in a downtown office district may have a very light traffic load in the middle of the night, a moderate traffic load on weekends, and a high or very high traffic load during rush hour and office hours on weekdays. Traffic loads may also vary based on factors other than time-of-day and location such as, for example, events. For instance, base stations having coverage areas that encompass stadiums, convention centers and other high capacity venues may experience very high traffic loads immediately before, after and during events, and may otherwise experience very low traffic loads. Base stations are typically designed to provide acceptable service during high traffic load events.

As the use of cellular devices has proliferated, including the wide usage of smart phones that are used for both voice and data traffic, traffic loads have skyrocketed. In order to support these high traffic loads, the number of deployed base stations has grown exponentially, and additional frequency bands have been added that support cellular communications. In order to support cellular service in multiple frequency bands, base stations typically now include multiple antennas and/or so-called multiband antennas that transmit and receive in multiple frequency bands, along with different radios that operate in each frequency band served by the base station.

Initially, each generation of cellular service was typically supported within a single frequency band at each base station. While the frequency bands used would vary based on the operator and/or the geographic location of the base station at issue, typically a first frequency band would be used to support first generation or “1G” cellular service, a second, different, frequency band would be used to support second generation or “2G” cellular service, and a third, different, frequency band would be used to support third generation or “3G” cellular service.

With the roll-out of fourth generation (“4G”) Long Term Evolution (“LTE”) service, a different, layered approach to coverage was taken that was implemented across multiple different frequency bands. In particular, in 4G LTE service, typically one of multiple frequency bands is designed to be a “coverage layer” that provides ubiquitous coverage to users throughout the entire cell. The additional frequency bands serve as “capacity layers” that provide additional capacity that can be used to accommodate high traffic loads. Typically, the cell is divided into sectors, such as three sectors that each cover about 120 degree in the azimuth plane, and thus multiple radios and antennas are used to implement each layer. The lowest frequency band (e.g., a frequency band within the 696-960 MHz frequency range) often serves as the coverage layer while the remaining frequency bands serve as capacity layers. Each capacity layer may or may not provide coverage to the entire cell. For example, some capacity layers may use more highly directive antenna patterns to provide large amounts of capacity to certain portions of a cell that typically experience high traffic loads. Work is ongoing to deploy 5G LTE networks that will have enhanced capacity and capabilities as compared to 4G LTE networks. These 5G LTE networks will use the same layered approach to coverage employed in 4G LTE networks, but may use a wider range of frequency bands and will likely use a greater number of frequency bands at a typical base station. However, both 4G and 5G LTE are “dumb” networks from an energy efficiency viewpoint.

When the traffic load within a cell supporting 4G LTE is light, the additional radios that transmit and receive signals in the capacity layers may be unnecessary since they are not required to provide connectivity to the users within the cell. However, because turning base station signal transmission equipment such as radios, baseband equipment, power amplifiers, low noise amplifiers, etc. on and off may raise various challenges, the unused or only lightly used signal transmission equipment may remain turned on and consuming power. In many situations it may be difficult for base stations to determine whether radios can be turned off without adversely affecting coverage within the cell. Additionally, turning off the radios operating at selected frequencies may result in service failure because some mobile users may only be capable of communicating in a single frequency band.

The cellular radios in use at base stations generate various data that is referred to as “key performance indicators.” These key performance indicators include data regarding traffic levels, the number of users within each cell as a function of time-of-day and day-of-the-week, user locations within the cell, the amount of voice versus data traffic, the quality of service provided at individual mobile users and various other information. This data is currently used to analyze radio coverage for the purpose of optimization and maintenance of the network. The radios also monitor the signal quality on each active link. If signal quality is deficient on a particular link, the base station may instruct individual user devices to increase the transmit power to improve the quality of service, and/or may instruct other user devices having high quality of service levels to decrease transmit power in order to reduce interference.

Pursuant to embodiments of the present invention, energy efficient solutions are provided for 4G LTE and 5G LTE networks and other advanced network technologies. As noted above, current 4G LTE networks are not designed for energy efficiency, and do not adaptively make adjustments to the network to reduce power consumption during times of lower traffic demand (other than through resource block allocation). The energy efficient solutions provided according to embodiments of the present invention analyze key performance indicators and other data to selectively reconfigure base station equipment in order to develop a “traffic awareness” capability within the network. This “traffic awareness” capability may be used at individual base stations to adaptively and automatically reconfigure base station equipment in a way that ensures that adequate coverage is provided to users within the cells served by the respective base stations while at the same time reducing the power consumption at the base stations. These changes may be made without compromising the experience of mobile users.

In some embodiments, scheduling algorithms may be implemented on a per base station basis to provide more energy efficient operation. The scheduling algorithm may, for example, be based on historical traffic load data to change the amount of capacity available as a function of time-of-day and/or the day-of-the-week. For example, traffic loads may be very high during particular times of particular days of a week, such as the times corresponding to the morning and evening commutes and lunch hour on workdays. At other times, such as between the hours of 11:00 pm and 5:00 am on any day of the week, traffic loads may be extremely light. The scheduling algorithm may take into account these known historical traffic patterns and reduce or increase the amount of resources operating at each base station based on the historical data regarding time-of-day and day-of-the-week traffic loads at that particular base station. As will be discussed in more detail below, the amount of power consumed at a base station may be a function of both the traffic load and the amount of resources operating at the base station. Different example ways for reducing or increasing the amount of resources for purposes of reducing power consumption at the base station will be described in more detail below.

In other embodiments, more dynamic means may be used to set the amount of resources operating at a base station to provide sufficient capacity throughout the cell while reducing power consumption. These more dynamic approaches may, for example, continuously monitor the traffic load at a particular base station and activate more resources when user traffic loads increase and deactivate resources when user traffic loads decrease. In both the scheduling algorithm approach and the more dynamic solutions, the base station may be designed to react to abrupt changes in the traffic pattern that could be caused, for example, by special events, natural disasters, emergency situations, news releases that generate increased network traffic, and the like.

The techniques that can be employed according to embodiments of the present invention to reduce power consumption during times of reduced traffic demand at a base station include, but are not limited to, (1) disabling one or more carriers in one or more of the capacity layers of the network while maintaining the coverage layer, (2) partially or fully disabling multi-input-multi-output (“MIMO”) capabilities at MIMO-capable base stations on selected carriers (which allows one or more radios to be disabled), (3) reducing the coverage footprint of one or more capacity layers by reducing transmit power, and (4) reconfiguring one or more radios from cross-polarized transmission to single polarization transmission.

Example embodiments of the invention will now be discussed in more detail with reference to the attached drawings.

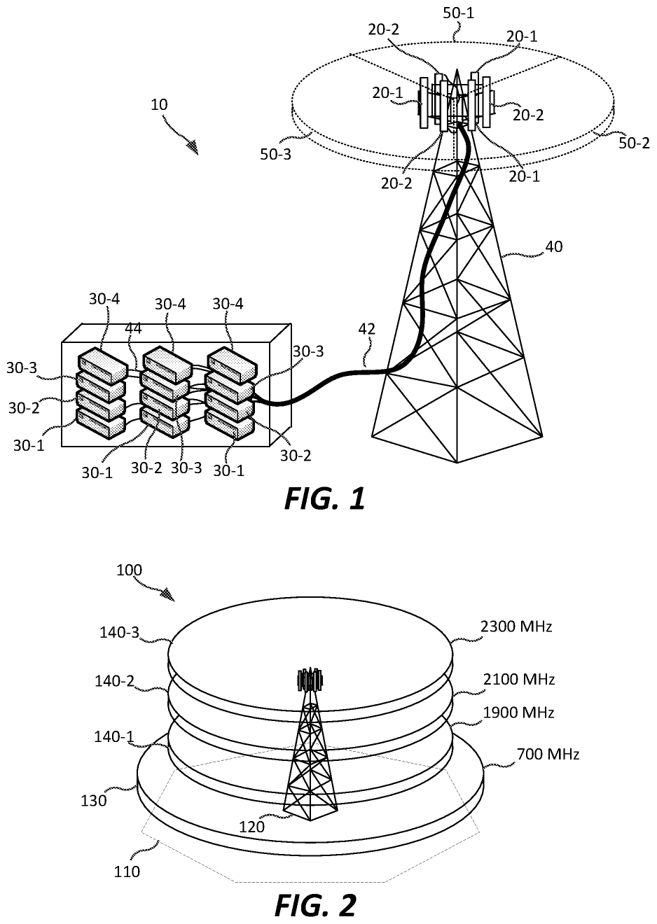

Referring to FIG. 1, a base station 10 is illustrated. The base station 10 is a sectorized base station that is divided into a plurality of sectors 50, with separate antennas and radios serving each sector. In the depicted embodiment, the base station 10 is divided into three sectors 50-1, 50-2, 50-3, where each sector 50, through its associated radios, antennas and other equipment, supports communications with fixed and mobile user devices within an area subtending an azimuth angle of approximately 120 degrees so that the three sectors 50-1, 50-2, 50-3 together provide full 360 degree coverage throughout the cell served by the base station 10. The sectors 50-1, 50-2, 50-3 are illustrated schematically in FIG. 1 via three pie-shaped wedges that together form a circular disk. The individual pie-shaped wedges illustrate the three sectors 50-1, 50-2, 50-3 and the full disk shows that the three sectors 50 together provide full 360 degree coverage of the cell 100 in the azimuth plane. It should be noted that herein when multiple like or similar elements are provided they may be labelled in the drawings using a two part reference numeral (e.g., sector 50-2). Such elements may be referred to herein individually by their full reference numeral (e.g., sector 50-2) and may be referred to collectively by the first part of their reference numeral (e.g., the sectors 50).

As shown in FIG. 1, the base station 10 includes a total of six antennas 20 that are mounted on a tower 40, with two antennas 20 for each of the three sectors 50. In the example base station of FIG. 1, a first antenna 20-1 in each sector 50 transmits and receives signals in the 746-787 MHz frequency band. A second antenna 20-2 in each sector 50 is a multiband antenna that transmits and receives signals in all three of the 1850-1990 MHz frequency band, the 2110-2170 MHz frequency band, and the 2305-2315 MHz and 2350-2360 MHz WCS frequency band. A multi-port radio 30-1 may be provided for each antenna 20-1, and three multi-port radios 30-2, 30-3, 30-4 may be provided for each antenna 20-2. Thus, a total of twelve radios 30 are provided. Each radio 30 may have, for example, two transmit ports and two receive ports. This may allow for the transmission and reception of signals in two different orthogonal polarizations in each frequency band within each sector 50. While the radios 30 are depicted as being located in an enclosure at the bottom of the tower 40 and connected to antennas 20 via an RF trunk cable 42 and jumper cables (not shown), it will be appreciated that more commonly the radios 30 are implemented as remote radio heads that are mounted at the top of the tower 40 directly behind and/or beneath the respective antennas 20. It will also be appreciated that various other signal transmission and other cell site equipment is not illustrated in FIG. 1 to simplify the drawings, such as tower mounted amplifiers, baseband equipment, power supplies, battery backups, connections to backhaul communications links and the like.

FIG. 2 is a schematic diagram illustrating the layered coverage architecture provided in 4G and 5G LTE networks. As shown in FIG. 2, a cell 100 in the LTE network has a base station 120 located therein that provides wireless connectivity to user devices throughout a coverage area 110 of the cell 100. The base station 120 may be implemented, for example, as the base station 10 discussed above with reference to FIG. 1, and hence may operate in several different frequency bands. As shown in FIG. 2, in one potential arrangement, the base station 120 will operate in four different frequency bands, the 700 MHz band (e.g., a 10 MHz or 20 MHz portion of the 746-757 MHz and 776-787 MHz frequency band), the 1900 MHz PCS frequency band (e.g., a 10 MHz or 20 MHz portion of the 1850-1990 MHz frequency band), the 2100 MHz AWS frequency band (e.g., a 10 MHz or 20 MHz portion of the 2110-2170 MHz frequency band), and the 2300 MHz WCS frequency band (e.g., the 2305-2315 MHz frequency band or the 2350-2360 MHz frequency band)

As is further shown in FIG. 2, one the four frequency bands may be designated as a coverage layer 130 that provides coverage throughout the cell 100. In the example embodiment of FIG. 2, the coverage layer 130 is provided by the 700 MHz frequency band. The three sector antennas 20-1 for the 700 MHz frequency band may have coverage patterns that together extend throughout the entire coverage area 110 of cell 100 and that provide sufficient gain to support communications with users anywhere in the cell 100. In contrast, the PCS, AWS and WCS frequency bands act as capacity layers 140-1, 140-2, 140-3 that provide additional capacity. The capacity layers 140 may or may not be designed to provide coverage throughout the entire cell 100.

Cellular radios, such as the radios 30, may have built-in high power amplifiers that consume large amounts of electrical power during operation. Power consumption at base stations may be a major component of the cost of operating a cellular network. While power consumption increases with increasing traffic loads, power consumption may still be high even during periods of low traffic loads, as equipment such as the radios, baseband units, power amplifiers, low noise amplifiers and the like are turned on and providing coverage throughout the cell. Moreover, each radio transmits control information on several reference channels during operation, and the power consumed by these control transmissions may be relatively independent of the amount of the traffic load. Transmission of this control data may account for perhaps 10-15% of the peak power consumption of a radio. Moreover, since the average power consumption of a cellular radio is typically well below the peak power consumption, the percentage of power consumption that results from supporting the control channels may be significant.

As discussed above, pursuant to embodiments of the present invention various key performance indicators and/or other data may be used to monitor the types and amount of traffic in a cell. The traffic load may be dynamically tracked in some embodiments, while more static tracking techniques may be used in other embodiments. One example of a static tracking technique is a time-of-day embodiment in which historical traffic data is used to model the expected traffic at a base station as a function of, for example, the time-of-day and the day-of-the-week. The historical traffic data may be used to determine when to employ the power consumption reduction techniques according to embodiments of the present invention and to determine the extent to which the power consumption reduction techniques are implemented. In other embodiments, the key performance indicators and other data may be continuously monitored to dynamically track the traffic load in the cell, and the power consumption reduction techniques may be implemented and modified dynamically to reduce power consumption while ensuring that sufficient resources are available to meet the traffic demand within the cell.

Examples of key performance indicators and other types of data that may be used as inputs to an algorithm that modifies the available capacity at a base station in order to reduce power consumption include (1) the number of connected users within the cell, (2) the total throughput on both the uplink and the downlink, (3) the dropped call rate within the cell, (4) the number of users that do not have service within the cell, (5) the resource block utilization (i.e., the percentage of the FDMA/TDMA time slots that are in use as a function of time), (6) the connection success rate, and (7) the user locations within the cell. It will be appreciated, however, that additional key performance indicators and other data may be used, and that not all of the above listed example data need be used in any particular algorithm.

As noted above, one simple example of an algorithm that may be used to implement power savings is to look at traffic history for each sector of a cell as a function of time-of-day and/or day-of-the-week. The traffic history data considered may include, for example, the number of connected users, the location of each connected user, the uplink and downlink throughput for each user and the resource block utilization level. This data may be used to specify on a time-of-day and/or day-of-the-week basis the amount of capacity reduction, if any, that may be implemented in each sector using the power consumption reduction techniques discussed herein. Typically, the reduction in capacity will be set with a goal of leaving sufficient capacity enabled so that no perceptible change in the user experience in terms of connection success rate, uplink and downlink throughput, dropped call rate, number of no service users, etc. will occur. Moreover, since the key performance indicators may be dynamically monitored, if a negative impact in the user experience starts to occur, the base station can exit the reduced power consumption mode, or at least enable additional resources, to increase the available capacity so that sufficient capacity is available to eliminate the negative impact on the user experience.

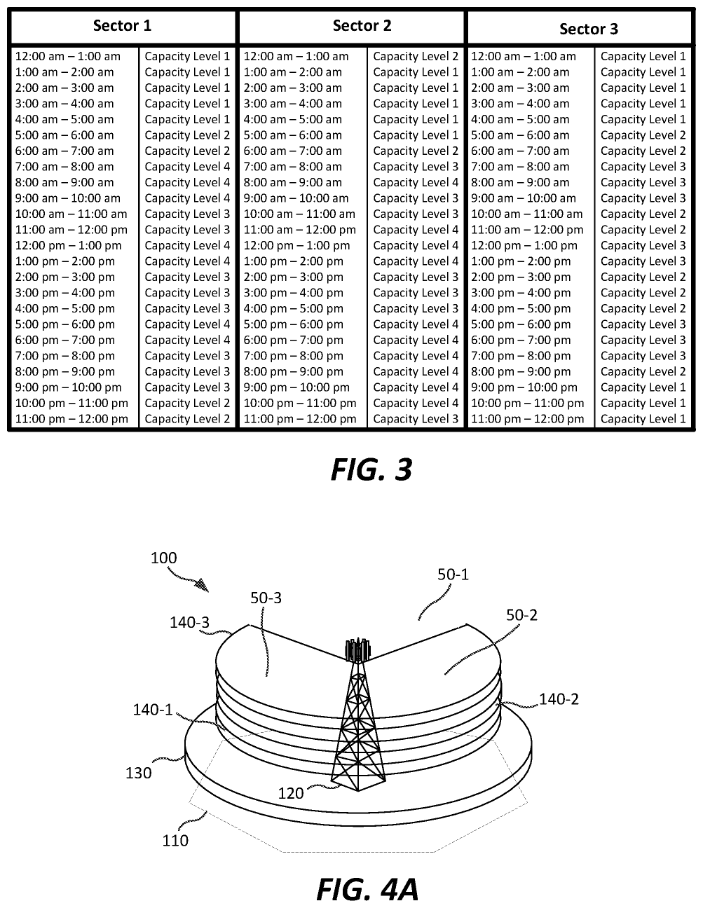

One specific example of such an algorithm is illustrated in FIG. 3. In this example, a time-of-day/day-of-the-week algorithm is used, and the capacity for each sector is specified at three different levels, denoted as Capacity Levels 1-4. Here it is assumed that each sector has the four layers 130, 140-1, 140-2, 140-3 discussed above with reference to FIG. 2. Capacity Level 4 may correspond to all three levels operating at full capacity. Operation at Capacity Level 4 does not result in any reduction in power consumption as compared to conventional operation of the base station. Capacity Level 3 corresponds to disabling the carrier in capacity layer 140-3 (as discussed below, disabling carriers is one of the example power consumption reduction techniques according to embodiments of the present invention). Capacity Level 2 corresponds to disabling the carriers in both capacity layer 140-2 and 140-3. Capacity Level 1 corresponds to disabling the carriers in all three capacity layers 140.

Each sector (labelled Sectors 1-3 in FIG. 3) may be pre-programmed to operate at a selected one of the Capacity Levels for each of twenty-four one-hour increments per day. In this simple example, the same schedule is used for seven days a week, although, more typically, one schedule would be used for each weekday and a different schedule would be used for weekends or weekends and holidays. The Capacity Level used for any sector in any given one-hour time slot may be selected based on an analysis of the historical traffic loads to ensure that sufficient capacity should available at all times to meet expected performance parameters. Thus, for example, if a review of the historical traffic data reveals that over the last month, during the 2:00 am-3:00 am time slot for Sector 2, the coverage layer 130 was sufficient to meet the traffic load over 99% of the time, then the algorithm may specify Capacity Level 1 for the 2:00 am-3:00 am time slot for Sector 2. This should allow for a significant reduction in power consumption with essentially no perceptible impact on the user experience. Similar analyses may be used to set the Capacity Levels for the remaining time slots for each sector. It will be appreciated that different time increments may be used.

After a plan for reducing power consumption has been set in, for example, the manner described above or any other appropriate way, the base station may start to operate according to the plan in a power consumption reduction mode. The base station can then monitor to see if the specified performance parameters are actually met in practice. If they are not, the base station may adaptively switch to a higher Capacity Level for time period/sector combinations where performance does not meet expectations. For example, if within a one-month period user performance goals are not met at least three times within a particular time slot for a particular sector in the table of FIG. 3, or if such performance expectations are not met at least twice within one week, then the Capacity Level for the slot may automatically be increased.

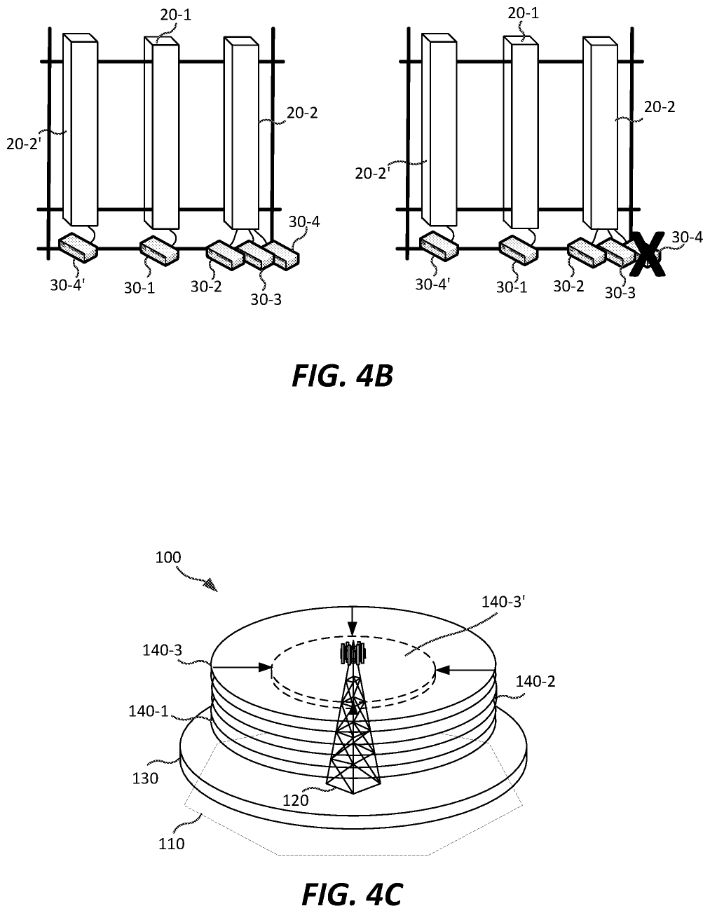

As noted above, a variety of different techniques may be used to reduce power consumption at a cellular base station during times of reduced traffic loads. FIGS. 4A-4C schematically illustrate three example power reduction techniques according to embodiments of the present invention.

In one example embodiment, the reduction in power consumption may be achieved by disabling one or more carriers in the capacity layers of the LTE network during times of reduced traffic loads within the cell. Here, a carrier may, for example, correspond to a radio. As discussed above, one of the layers of LTE service, typically the 700 MHz frequency band, is used as a coverage layer 130 that provides ubiquitous coverage throughout the cell 100. This coverage layer 130 may be provided by the three radios 30-1 that transmit in the 700 MHz frequency band in the respective three sectors 50. The remaining frequency bands provide additional capacity (i.e., serve as capacity layers). When traffic loads within the cell 100 are low, one or more of the capacity layers 140 in one or more of the sectors 50 may be partially or fully disabled by, for example, turning off the radios 30 that implement these capacity layers 140 or having the radios 30 enter into a low-power standby mode. For example, in the embodiment of FIG. 2, one of the capacity layers 140 could be disabled during time periods when the traffic load is low. The radios 30 could be turned off in all three sectors 50 or only in selected sectors 50 depending upon the traffic loads in each respective sector 50 and/or the locations of the users. When the radios 30 are disabled, the control transmissions are likewise disabled, which can result in significant power savings. Additional savings may be realized by entering the disabled radios 30 into a low power mode or turning them off altogether. These power savings may often be realized with little or even no perceptible impact on the user experience by using traffic analytics to intelligently assign users to fewer of the layers 130, 140-1, 140-2, 140-3 during times where the traffic load in the cell 100 is light.

It should be noted that base stations are typically configured to have sufficient resources to meet peak traffic loads with acceptable quality of service. Typically, a base station will operate at or near peak traffic loads for only a small percentage of the time, such as 10% of the time or less, and may operate during significant portions of the day at very low traffic levels. Thus, the power consumption reduction techniques according to embodiments of the present invention may be employed during a significant portion of each day at a typical cellular base station. During some periods of time, only limited use of the power consumption reduction techniques may be employed as the base station may experience moderate traffic loads and it may be necessary to have some resources instantly available to satisfy a sudden spike in the traffic load. During such times, perhaps only one of four carriers in an example sector 50 may be disabled. However, at other times, such as during the middle of the night, it may be possible to, for example, disable all of the equipment associated with all of the capacity layers 140. This can result in a significant reduction in power consumption, and hence can significantly lower the costs of operating the base station.

The technique of disabling carriers in the capacity layers is schematically illustrated in FIG. 4A. In the example of FIG. 4A, the base station 110 has a coverage layer 130 and three capacity layers 140-1, 140-2, 140-3 and is divided into three sectors 50-1, 50-2, 50-3. As shown in FIG. 4A, during periods when the traffic load within a particular sector 50 (here sector 50-1) of the cell 100 is moderate, one of the capacity layers 140 (here capacity layer 140-3) may be disabled in that sector 50-1 in order to reduce the power consumption. It will be appreciated that the radios 30 implementing any of the capacity layers 140 in any of the sectors 50 may be disabled, as appropriate, based on the analysis of the current or historical traffic loads for the cell 100 and the sectors 50 thereof.

It will be appreciated that before implementing the power consumption reduction techniques of FIG. 4A it may be necessary to switch any user devices that are operating in the capacity layer that is to be disabled (e.g., capacity layer 140-3) to either the coverage layer 130 or to a different capacity layer 140-1, 140-2.

When a static traffic awareness technique is used such as a time-of-day/day-of-the-week traffic awareness model, the carriers are disabled and re-enabled based on the static model. Thus, for example, while most or all of the carriers that implement the capacity layers 140 may be disabled at a base station 120 overnight, in the morning those carriers may be re-enabled in anticipation of increased traffic levels. It will also be appreciated that if a sudden, unanticipated surge in traffic occurs, as might happen in response to a natural disaster, breaking news or the like, such that traffic exceeds the expected traffic for the cell 100, additional carriers may be automatically enabled until traffic has returned to normal levels for some period of time. In some embodiments, the base station 120 may simply exit the reduced power consumption mode when such unanticipated increases in traffic occurs. In other embodiments, the base station 120 may bring one or more additional carriers on line in response to an unanticipated increase in traffic, but may remain in the reduced power consumption mode, albeit with the base station 120 configured to support higher capacity levels. Typically, a radio 30 may quickly exit the power savings mode and hence may be quickly brought back into use. Accordingly, even if a sudden, unanticipated surge in traffic occurs within a cell 100, it may result in at most a very brief period where users are denied service.

A second method for reducing power consumption according to embodiments of the present invention is to reduce or disable MIMO capabilities in one or more layers during times of lower traffic demand. As known to those of skill in the art, MIMO refers to a technique where a signal is transmitted by multiple radios through multiple different antenna arrays (or sub-arrays) that are typically horizontally spaced apart from one another. The use of MIMO transmission techniques may account for multipath fading, reflections of the transmitted signal off of buildings and the like and other transmission effects to provide enhanced transmission quality. MIMO, however, also requires the use of multiple radios, and hence typically results in increased power consumption.

Typical MIMO-capable base stations today include two, four or even eight horizontally spaced-apart linear array antennas (which may be implemented as one or multiple separate antennas). During periods where the traffic load in a sector is low, the extent to which MIMO transmission techniques are employed may be reduced or eliminated. For example, if a base station implements MIMO transmission using eight separate radios, the number of radios used may be reduced to four, two or even one, with a resultant reduction in power consumption as the unused radios may be set into a power savings mode or turned off altogether. Moreover, in some cases, the amount of bandwidth assigned to each user on the radios that remain in use may be increased a corresponding amount. For example, a user who receives 20 kHz of bandwidth during transmission in two-radio MIMO mode may receive 40 kHz of bandwidth when the second radio is turned off for purposes of reducing power consumption. The additional bandwidth may be available because the traffic load in the sector at issue is light. The increase in bandwidth may help offset the reduction in the quality of the cellular signal that may occur as a result of switching from MIMO to SISO transmission in this example. In other embodiments, the transmit power levels may be increased on the remaining radio instead of changing the bandwidth to provide the same effect.

FIG. 4B schematically illustrates the approach for reducing power consumption by decreasing the degree to which MIMO transmissions are used at a base station. As shown on the left side of FIG. 4B, during normal operation, a first radio 30-1 transmits signals through a first antenna 20-1 to implement a coverage layer 130 in a sector of the cell. Radios 30-2, 30-3, 30-4 may also be provided that transmit through a second antenna 20-2 to implement three respective capacity layers 140-1, 140-2, 140-3 in that sector. Additionally, a fourth radio 30-4′ that transmits through a third antenna 20-2′ is provided. The fourth radio 30-4′ and the third radio 30-4 may transmit in the same frequency band and may be configured to transmit signals using MIMO transmission techniques. Thus, the third capacity layer 140-3 is formed in the sector illustrated using MIMO transmission techniques.

As shown on the right side of FIG. 4B, during time periods where the traffic load in the sector is reduced, one of the two radios 30-4, 30-4′ (here radio 30-4) may be turned off (or set to a low power standby mode). As a result, only the radio 30-4′ is used to form the third capacity layer 140-3. By turning off radio 30-4, the power consumption at the base station may be reduced.

Referring to FIG. 4C, in still other embodiments, the power consumption at a base station 120 may be reduced by setting the power amplifiers in one or more of the radios that implement the capacity layers 140 at reduced transmit power levels (and similar reductions in power may be done on the low noise amplifiers that amplify the received signals). The effect of this reduction in power is to reduce the amount of the coverage area 110 that is served by the capacity layers 140. As discussed above, the capacity layers 140 need not provide coverage to the entire cell 100, as the coverage layer 130 may be used to support communications anywhere throughout the cell 100. As shown in FIG. 4C, when the transmit power is reduced for one of the capacity layers 140-3, the portion of the cell covered by that capacity layer decreases to, for example, the region 140-3′ shown in FIG. 4C, as the reduced transmit power may be insufficient to support a desired quality of service level for user devices located near the edge of the cell 100. User devices that are outside of the reduced coverage area 140-3′ for capacity layer 140-3 operating under reduced peak transmit power levels may be supported by the coverage layer 130 or by another capacity layer 140-1, 140-2 that has a coverage pattern that covers those user devices. The reduction in the transmit power for capacity layer 130 may result in a significant reduction in power consumption. While in the example of FIG. 4C, the transmit power for the radios implementing capacity layer 140-3 are reduced in all three sectors, it will be appreciated that only a subset of the sectors may be reconfigured to operate at reduced transmit power levels.

The power consumption reduction technique illustrated in FIG. 4C may be particularly advantageous as it may often be applied even during periods where the traffic load in the cell is moderate or even high. In particular, so long as the user devices in the outer portion of the cell can be serviced using the coverage layer 130 (with sufficient additional capacity being available in the coverage layer 130 to support a sudden increase in traffic from users located near the edge of the cell), then the transmit power on all of the capacity layers 140 may be reduced. Note that as with the embodiment described above with reference to FIG. 4A, it may be necessary to switch users from one layer to another prior to implementing the power consumption reduction scheme that is schematically illustrated with reference to FIG. 4C.

One additional technique for reducing power consumption is to only transmit and receive signals on one polarization of a radio that has the capability to transmit and receive signals at two orthogonal polarizations. Most base station radios are configured to support dual-polarized communications, where the second polarization may be used as a second independent channel or to counteract channel effects such as multipath fading. When the second polarization is used as a separate channel, it may be simple to disable the port for the second polarization on one or more radios that implement a capacity layer. This approach may yield power consumption savings similar to the first approach discussed above with reference to FIG. 4A.

It will be appreciated that the power consumption reduction techniques disclosed herein may be applied to all of the sectors of a base station or only to selected sectors, depending upon the design of the system and the location of mobile users within the cell.

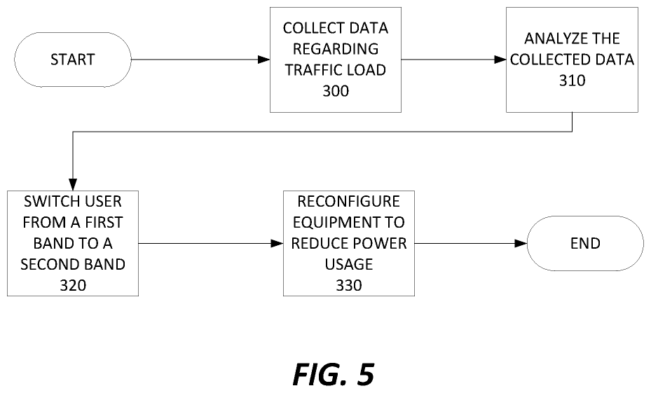

FIG. 5 is a flow chart illustrating a method of operating a cellular base station according to certain embodiments of the present invention. As shown in FIG. 5, according to this method operations may begin with the collection of data regarding a traffic load at the cellular base station (Block 300). The cellular base station supports service in at least two different transmit/receive frequency bands such as, for example, the 700 MHz frequency band, the 1900 MHz PCS frequency band and the 2100 AWS frequency band. The collected data may then be analyzed (Block 310). This analysis may comprise, for example, an analysis of historical traffic load data that is used to establish a schedule for reconfiguring signal transmission equipment at the cellular base station or may comprise a dynamic analysis that is used to dynamically reconfigure the cellular base station. Then, at least one mobile user may be switched from communicating in a first of the transmit/receive frequency bands to communicating in a second of the transmit/receive frequency bands (Block 320). After one or more such mobile users have been switched to the second of the transmit/receive frequency bands, signal transmission equipment at the cellular base station is reconfigured to reduce power consumption at the cellular base station (Block 330). This reconfiguration may be based on a prior or current analysis of the collected data regarding the traffic load at the cellular base station.

It will be appreciated that the methods according to embodiments of the present invention may be partially or fully automated. For example, referring again to FIG. 5, the data that is collected in Block 300 may be automatically collected by, for example, the radios at a base station in some embodiments. The analysis of the collected data that is described with reference to Block 310 may also be performed automatically by, for example, a computer or other processing device that may be located at the base station or elsewhere. The switching of one or more mobile users from communicating in a first transmit/receive frequency band to communicating in a second transmit/receive frequency band that is described with reference to Block 320 of FIG. 5 may also be automatically performed. Additionally, the reconfiguration of the signal transmission equipment at the cellular base station to reduce power consumption by, for example, disabling radios, disabling MIMO operation, disabling cross-polarized operation and/or by reducing the peak power for some radios may occur automatically.

In some embodiments, one or more of the operations described at Blocks 310 through 330 of FIG. 5 may be performed by a processor that runs computer program code for carrying out the operations described therein. These computer program instructions may be provided to a processor of a general purpose computer, special purpose computer, or other programmable data processing apparatus to produce a machine, such that the instructions, which execute via the processor of the computer or other programmable data processing apparatus, implement the functions/acts specified in the flowchart blocks. The computer program code may be stored in any tangible computer-usable storage medium including, for example, hard disks, CD-ROMs, optical storage devices, or magnetic storage devices. The computer program code may be written, for example, in an object oriented programming language such as Java®, Smalltalk or C++, in a conventional procedural programming language, such as the “C” programming language, or in any other suitable computer programming language. The program code may execute entirely on a single computer/processor or may execute on multiple interconnected computers/processors.

The present invention has been described above with reference to the accompanying drawings. The invention is not limited to the illustrated embodiments; rather, these embodiments are intended to fully and completely disclose the invention to those skilled in this art. In the drawings, like numbers refer to like elements throughout. Thicknesses and dimensions of some elements may not be to scale.

Spatially relative terms, such as “under”, “below”, “lower”, “over”, “upper”, “top”, “bottom” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity. As used herein the expression “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

An embodiment of the present invention is described with reference to the flowchart diagram of FIG. 5. It will be appreciated that the operations shown in the flowchart diagram need not necessarily be performed in the order shown and that in some cases it may be possible to perform two or more of the operations simultaneously.

1. A method of operating a cellular base station, the method comprising:
collecting data regarding a traffic load at the cellular base station, where the cellular base station supports service in at least a first transmit/receive frequency band and a second transmit/receive frequency band that is different than the first transmit/receive frequency band;
analyzing the collected data; and
automatically reconfiguring signal transmission equipment at the cellular base station to reduce power consumption at the cellular base station based on the analysis of the collected data.

2. The method of claim 1, wherein the first transmit/receive frequency band comprises a first capacity layer of the cellular base station and the second transmit/receive frequency band comprises a coverage layer of the cellular base station.

3. The method of claim 2, the method further comprising, in response to the analysis of the collected data, switching at least one mobile user from communicating in the first transmit/receive frequency band to communicating in the second transmit/receive frequency band prior to reconfiguring signal transmission equipment at the cellular base station to reduce power consumption at the cellular base station based on the analysis of the collected data.

4. The method of claim 3, wherein reconfiguring signal transmission equipment at the cellular base station to reduce power consumption at the base station comprises disabling a first radio.

5. The method of claim 4, wherein disabling the first radio comprises turning off the first radio or setting the first radio into a low power standby mode of operation.

6. The method of claim 1, wherein reconfiguring signal transmission equipment at the cellular base station to reduce power consumption at the cellular base station based on the analysis of the collected data comprises reconfiguring the cellular base station to use fewer radios for multiple-input-multiple-output (“MIMO”) transmissions to at least one user or to switch from MIMO transmissions to single-input-single-output (“SISO”) transmission to the at least one user based on the analysis of the collected data in order to reduce power consumption at the cellular base station.

7. The method of claim 6, further comprising increasing the amount of bandwidth assigned to the at least one user when switching the at least one user to SISO transmission.

8. The method of claim 2, wherein reconfiguring signal transmission equipment at the cellular base station to reduce power consumption at the cellular base station based on the analysis of the collected data comprises reducing a peak transmit power for a first radio so that a first coverage area for a first sector of the first capacity layer is reduced to a second coverage area for the first sector that is smaller than the first coverage area in order to reduce power consumption at the cellular base station.

9. The method of claim 8, further comprising, in response to the analysis of the collected data, switching at least one mobile user that is located in a portion of the first sector that is within the first coverage area but that is not within the second coverage area from communicating in the first transmit/receive frequency band to communicating in the second transmit/receive frequency band prior to reconfiguring the signal transmission equipment.

10. The method of claim 1, wherein the first radio includes a first transmit port that is connected to first radiating elements of an antenna that are configured to transmit and receive signals having a first polarization and a second transmit port that is connected to second radiating elements of an antenna that are configured to transmit and receive signals having a second polarization that is orthogonal to the first polarization, and wherein reconfiguring signal transmission equipment at the cellular base station to reduce power consumption at the cellular base station based on the analysis of the collected data comprises disabling the second transmit port while continuing to transmit signals through the first transmit port.

11. The method of claim 2, wherein analyzing the collected data comprises developing a static algorithm for reconfiguring the signal transmission equipment at the cellular base station to reduce the power consumption at the cellular base station based on the analysis of the collected data.

12. The method of claim 11, wherein the static algorithm reconfigures the signal transmission equipment at the cellular base station based on a time of day and/or a day of the week.

13. The method of claim 11, further comprising:
determining that insufficient signal transmission equipment is available to meet the traffic load after reconfiguring the signal transmission equipment at the cellular base station; and
enabling additional signal transmission equipment at the cellular base station.

14. The method of claim 2, wherein reconfiguring signal transmission equipment at the cellular base station to reduce power consumption at the cellular base station based on the analysis of the collected data comprises dynamically reconfiguring signal transmission equipment at the cellular base station in response to changes in the traffic load.

15. The method of claim 2, wherein the collected data includes at least one of a number of connected users within the cell, a total throughput, a dropped call rate, a number of users that do not have service, a connection success rate, and user locations within a cell served by the cellular base station.

16. The method of claim 2, wherein reconfiguring signal transmission equipment at the cellular base station to reduce power consumption at the cellular base station based on the analysis of the collected data comprises reconfiguring signal transmission equipment for a first sector of the cellular base station to reduce power consumption while not reconfiguring signal transmission equipment for a second sector of the cellular base station based on the analysis of the collected data.

17. A method of operating a cellular base station, the method comprising:
collecting data regarding a traffic load at the cellular base station, where the cellular base station supports service in at least two different transmit/receive frequency bands;
analyzing the collected data;
automatically switching users from communicating in a first transmit/receive frequency band that comprises a first capacity layer of the cellular base station to a second transmit/receive frequency band that comprises a coverage layer of the cellular base station in response to determining that at least one sector of the first capacity layer is not necessary to support the traffic load at the cellular base station; and
automatically reconfiguring a radio at the cellular base station that is connected to an antenna for the first sector of the first capacity layer to reduce power consumption at the cellular base station based on the analysis of the collected data.

18. The method of claim 17, wherein reconfiguring the radio comprises turning off the radio or setting the radio into a low power standby mode of operation.

19. The method of claim 17, wherein reconfiguring a radio comprises reducing a peak transmit power for the radio so that a coverage area for the first sector of the first capacity layer is reduced.
